(19) United States
(12) Patent Application Publication
(10) Pub. No.: US 2026/0310575 A1
(43) Pub. Date: Oct. 8, 2026

(54) Behavioral-Based Phase-of-Execution Inference Using Processing Unit Execution Events

(71) Applicant: Arm Limited, Cambridge (GB)

(72) Inventors: Michael BARTLING, Austin, TX (US); Brendan James MORAN, Coton (GB); Casey John Battaglino, Austin, TX (US)

(21) Appl. No.: 19/459,675

(22) Filed: Jan. 26, 2026

Related U.S. Application Data
(60) Provisional application No. 63/783,486, filed on Apr. 4, 2025.

(51) Int. Cl. G06F 11/3604; G06F 18/22; G06N 5/04

(52) U.S. Cl. CPC G06F 11/3604; G06F 18/22; G06N 5/04

(57) ABSTRACT

A method and system for inferring a phase-of-execution of code in a processing unit are disclosed. A behavioral sensor receives a sequence of behavior indicators derived from processor-level execution events detectable at a microarchitectural level of the processing unit. A phase inference engine constructs one or more observed behavior signatures from the sequence and correlates the observed behavior signatures with stored profiles associated with known execution phases. Based on this correlation, the system infers a current phase-of-execution of the code. The inference may include assigning a confidence value or probability to the inferred phase. Dependent embodiments provide for storing new behavior signatures, updating profiles, or using phase information to guide subsequent execution. The disclosed approach enables accurate, fine-grained identification of execution phases based on microarchitectural behavior, improving observability of processor execution beyond conventional software or system-level tracing.

### CROSS-REFERENCE TO RELATED APPLICATIONS

This application claims the benefit of U.S. Provisional Application No. 63/783,486, filed Apr. 4, 2025, the entire contents of which are incorporated herein by reference.

### BACKGROUND

Central Processing Units (CPUs) with performance monitoring capabilities, such as a performance monitoring unit (PMU), can produce detailed information about internal operations of the processor. This information is expressed as processor-level execution events observable at the microarchitectural level. Such events include negative results (e.g., branch mispredictions, cache misses) as well as positive results (e.g., retired instructions, completed loads and stores). Modern processors execute at extremely high speeds, generating millions of such events every second, if not more.

The sheer volume of processor-level execution events makes it difficult for other devices or processes to consume the information in an actionable manner. Known approaches often either discard underlying data fidelity or introduce prohibitive latency. However, to be useful, execution event information must be leveraged in a way that preserves fidelity while enabling near real-time correlation, since excessive delay between event occurrence and subsequent action may render the information ineffective.

### BRIEF SUMMARY

Behavioral-based phase-of-execution inference using patterns in processor-level execution events is disclosed. In some embodiments, a behavioral sensor observes a stream of microarchitectural events generated during execution and constructs behavior indicators representative of execution behavior. A phase inference engine correlates these indicators with pre-established profiles to infer whether the current execution stream corresponds to a known, higher-order phase-of-execution. Performing such inference in actionable time allows optimizations or tuning actions to be applied that improve processor efficiency. Conversely, taking actions based on an incorrect or delayed phase inference can degrade performance.

In some aspects, a method of inferring a phase-of-execution of code in a processing unit includes: receiving, via a behavioral sensor, a sequence of behavior indicators derived from processing-unit execution events detectable at a microarchitectural level of the processing unit during execution of code; constructing, from the sequence of behavior indicators, one or more observed behavior signatures representative of execution behavior; pattern-matching the one or more observed behavior signatures to a catalog of stored behavior signatures maintained in a profile storage medium, the stored behavior signatures being associated with specific phases-of-execution; and inferring, based on the pattern-matching, a phase-of-execution of the code being executed.

In some aspects, a method of predicting an upcoming phase-of-execution of code in a processing unit, includes: receiving, via a behavioral sensor, a sequence of behavior indicators derived from processing-unit execution events detectable at a microarchitectural level of the processing unit during execution of code; analyzing a temporal order of the behavior indicators in the sequence; comparing the temporal order of the behavior indicators to a catalog of stored behavior patterns associated with specific phases-of-execution; and predicting, based on a comparison resulting from the comparing, a subsequent phase-of-execution of the code prior to execution of instructions corresponding to the subsequent phase-of-execution.

In some aspects, a system for inferring a phase-of-execution of code in a processing unit, includes: a behavioral sensor configured to capture a sequence of behavior indicators derived from processing-unit execution events detectable at a microarchitectural level of the processing unit during execution of code; a profile storage medium configured to store a catalog of behavior signatures associated with specific phases-of-execution; and a phase inference engine configured to: construct one or more observed behavior signatures from the sequence of behavior indicators; pattern-match the one or more observed behavior signatures to the catalog of stored behavior signatures; and infer, based on the pattern-matching, a phase-of-execution of the code being executed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates an example architecture for behavioral-based phase-of-execution inference.

FIG. 1B illustrates a representational schematic of a behavioral sensor for generating output including behavioral indicators.

FIG. 2A illustrates a specific implementation of a system with a behavioral sensor used to determine phase-of-execution from processing unit events.

FIG. 2B illustrates a specific implementation of the preprocessing circuitry present in some embodiments of the system of FIG. 2A.

FIG. 2C shows a schematic diagram where a machine learning (ML) profiler establishes the behavioral signatures of the profile storage medium.

FIG. 3A illustrates an example method of inferring a phase-of-execution of code in a processing unit.

FIG. 3B illustrates an example method of predicting a subsequent phase-of-execution of code in a processing unit.

FIG. 3C illustrates an embodiment of tuning processor resources based on a predicted phase-of-execution.

FIG. 3D illustrates an embodiment for generating a catalog of behavior signatures through supervised training.

FIG. 4A provides a sample use case for predicting phase-of-execution and for responsively tuning a processing unit to improve performance.

FIG. 4B provides a simple machine learning example consistent with FIG. 1A.

### DETAILED DESCRIPTION

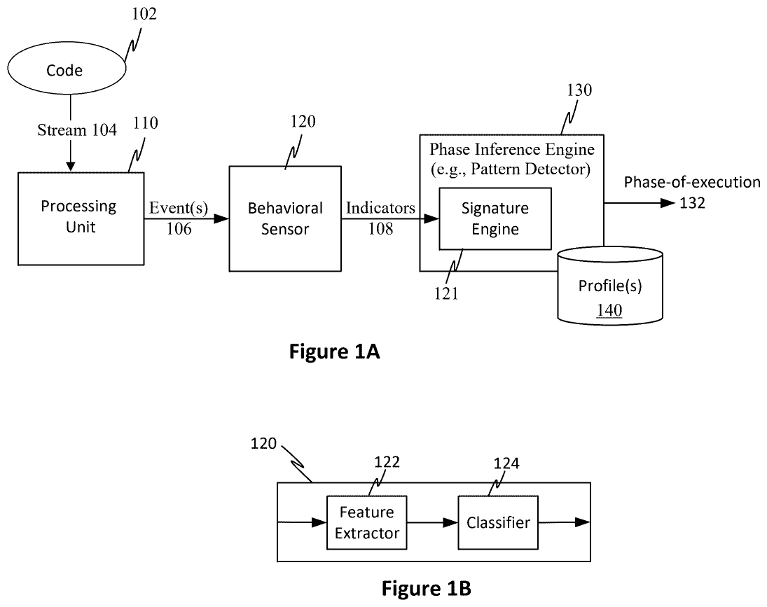

Behavioral-based phase-of-execution inference using processor-level execution events is disclosed. In one aspect, a behavioral sensor (see FIG. 1A) observes execution events at the microarchitectural level of a processor and derives behavior indicators that capture features of processor activity. These indicators can be combined into observed behavior signatures representative of execution behavior, which are compared against a catalog of stored behavior signatures maintained in a profile storage medium associated with known phases-of-execution. As used herein, a ‘phase-of-execution’ refers to a relatively high-order stage of program behavior that persists for a region of execution and is distinguishable by patterns of processor-level execution events. In certain embodiments, the disclosed inference models may be lightweight and hardware-agnostic, enabling consistent phase inference across processor architectures and generations.

For example, phases-of-execution may correspond to algorithmic regions (e.g., LZ77 compression vs. Huffman coding in DEFLATE), functional modes (e.g., initialization, steady-state processing, or cleanup), or other segments of code execution that exhibit characteristic microarchitectural behavior. Correctly and timely inferring the phase-of-execution enables tuning of processor resources for a specific workload, thereby improving performance. To be effective, phase inference should occur quickly enough to anticipate or overlap with the upcoming phase transition, rather than lag behind it. Moreover, the tuning action must yield benefits that outweigh its own computational or timing overhead, so that the adjustment produces a net performance gain.

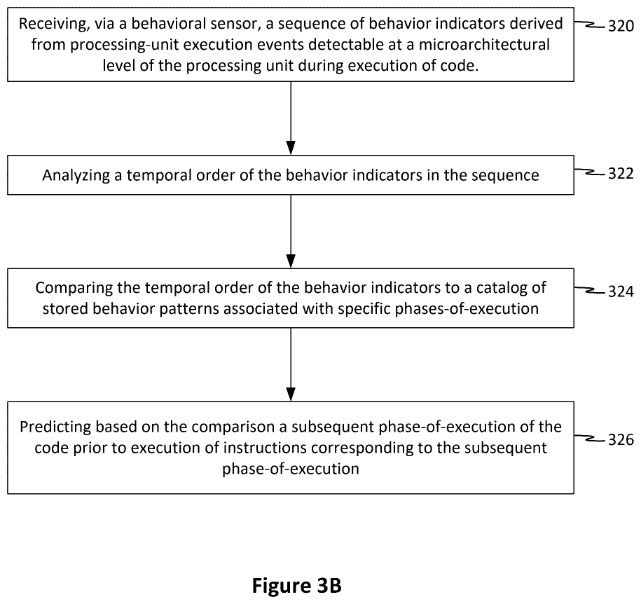

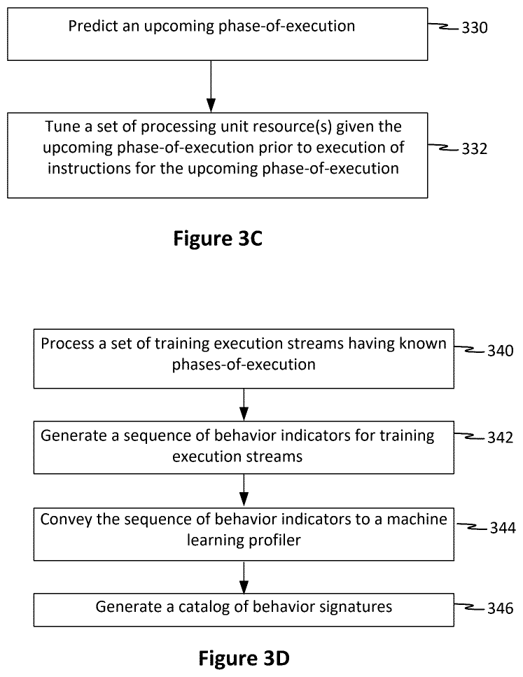

Consider that modern processors can generate more than 500,000 execution events in less than one second, and in some contexts an effective phase-of-execution inference must be made in under one millisecond to remain actionable. Accordingly, a phase inference engine may need to operate in near real time to pattern-match observed behavior signatures to stored profiles, infer the current phase, and in some embodiments predict an upcoming phase-of-execution (see FIG. 3C). Timing considerations are significant, as they constrain a level of depth of analysis/processing used to infer a phase-of-execution, as many processor intensive approaches would simply not complete in a timely enough manner to enable the inferred phase-of-execution to be beneficially used. Embodiments of the disclosure support proactive performance tuning based on the phase-of-execution inference prior to execution of the subsequent phase for which tuning is tailored.

The behavioral-based inference methodology disclosed herein is superior to structural approaches, because it operates independently of the architectural details of the underlying processor, ensuring functionality across hardware generations. Moreover, behavioral-based inference occurs dynamically at runtime without relying on prior knowledge of the source code structure or compilation details. This allows general-purpose application across workloads and platforms, while maintaining fidelity to microarchitectural behavior.

FIG. 1A illustrates an example architecture for behavioral-based phase-of-execution inference. Code 102 is streamed 104 to and is executed by a processing unit 110, which results in occurrences of processor-level execution events 106. A behavioral sensor 120 observes these events and derives behavior indicators 108 that capture salient aspects of execution behavior at the microarchitectural level. The indicators 108 are provided to a phase inference engine 130, which includes a signature engine 121 configured to construct one or more observed behavior signatures and to pattern-match them against stored profiles 140. These profiles 140 represent a catalog of known phases-of-execution, allowing the phase inference engine 130 to output an inferred phase-of-execution 132 for the running code stream. In some embodiments, the inference engine 130 operates in near real time, such that the inferred phase can be acted upon before a subsequent phase transition occurs. Generally the phase inference engine 130, which can be referred to as a pattern detector, produces an inferred phase-of-execution 132, in a manner that enables tuning or optimization actions that improve processing unit 110 performance without incurring overhead that would negate the benefit. The system of FIG. 1A can operate in a platform-independent manner performed without assumptions about or reliance on the codebase structure

As used herein, code 102 represents any software, firmware, or instruction sequence executed by the processing unit 110. In some embodiments, code 102 may include application software, kernel-level code, library functions, or firmware routines. The execution stream 104 refers to the dynamic flow of instructions. The stream 104 represents the dynamic flow of code execution on the processing unit 110. This flow can be observed in terms of processor-level execution events generated at the microarchitectural level, such as instruction retirements, cache accesses, branch predictions, or memory requests. Order and timing sequences of processor level events resulting from the flow can be significant. In some embodiments, the processor-level execution events are collected as a continuous trace of activity, while in other embodiments they may be sampled to form a representative sequence.

The processing unit 110 may include one or more processor elements, such as a central processing unit (CPU), graphics processing unit (GPU), microcontroller, or specialized computing element (e.g., a multiplier-accumulator (MAC) unit with memory). In some embodiments, the execution stream is captured as discrete events, rather than as aggregated samples, to preserve timing fidelity.

The execution events 106 can include processor-level events detectable at the microarchitectural level of the processing unit 110. Such events may be generated, for example, by a performance monitoring unit (PMU) or other functional components of the processor microarchitecture, including branch predictors, caches, execution pipelines, prefetchers, memory controllers, and translation lookaside buffers (TLBs). The events can capture both positive outcomes (e.g., an instruction retired, a store completed, a cache hit) and negative outcomes (e.g., branch misprediction, cache miss, TLB miss, pipeline stall). In some embodiments, the events 106 may further include timing information or counts, such as cycles elapsed between events or event frequency, which can be used to characterize execution behavior. Collectively, these processor-level events 106 form the raw behavioral signal from which indicators 108 are derived.

The behavioral sensor 120 converts the raw execution events 106 into behavior indicators 108, which may encode both the occurrence of local events and their relative timing. A sequence of such indicators provides higher-level information that the phase inference engine 130 can use for signature matching. In some embodiments, the behavior indicators 108 can be considered ‘consumable events’ as described in U.S. Pat. No. 12,147,326, titled Behavioral Sensor for Creating Consumable Events. That disclosure illustrates one particular embodiment of a behavioral sensor, in which raw processor-level events are transformed into standardized, consumable indicators suitable for downstream analysis. The present behavioral sensor 120 encompasses such embodiments, as well as other mechanisms that derive structured, higher-level indicators from the microarchitectural event stream.

Behavioral indicators 108 are derived signals that abstract raw execution events 106 into higher-level representations of processing unit behavior. For example, an individual indicator may encode the occurrence of a cache miss, a branch misprediction, or a retired instruction, as well as the relative timing between such events. A sequence of behavioral indicators 108 thus captures meaningful execution patterns at the microarchitectural level, providing a compact and consumable representation of the workload's behavior for further analysis.

Phase inference engine 130, which can also be referred to as a pattern detector, consumes the behavioral indicators 108 and identifies phases-of-execution based on these inputs. In some embodiments, the phase inference engine 130 includes a signature engine 121 that constructs observed behavior signatures from the incoming behavioral indicators 108 and pattern-matches them against a catalog of stored profiles 140 representing known execution phases. A behavior signature is a structured representation of an execution phase, defined by a specific sequence or arrangement of behavioral indicators 108. In practice, a behavior signature need not correspond to a complete sequence of events; rather, it may capture characteristic patterns that provide a statistical likelihood of correspondence to a given phase-of-execution. Each such signature reflects the characteristic microarchitectural activity of a phase-of-execution and can be stored in the profile storage medium for later comparison against observed sequences.

Based on this comparison, the phase inference engine 130 outputs at least one phase-of-execution 132, optionally accompanied by a confidence value. The confidence value may increase as additional matching signatures are observed, and may also be refined using contextual information such as the identity of preceding phases (since certain phases are more likely to follow others). In this way, probabilistic modeling can reinforce or refine the inference over time, improving the likelihood of correct detection. In some embodiments, behavior signatures are established or refined using machine learning techniques, and the inference engine may further employ fuzzy logic or state-machine approaches. The inference engine 130 may be realized in hardware (e.g., logic gates, ASIC) or software executed by a processor (either the same processing unit 110 or a different one). In certain embodiments, the inference engine 130 operates in near real time, enabling optimizations or tuning actions to be performed before a subsequent phase transition occurs.

As used herein, a phase-of-execution 132 refers to a relatively high-order stage of program behavior that persists over a region of execution and is distinguishable by characteristic patterns of processor-level execution events. For example, phases 132 may correspond to algorithmic regions (e.g., compression vs. coding), functional modes (e.g., initialization, steady-state operation, cleanup), or other segments of execution that exhibit repeatable microarchitectural behavior. Each phase-of-execution 132 typically engages processor resources in a distinct way—such as exercising caches, branch predictors, or memory pipelines differently from other phases—and can therefore be selectively optimized or tuned. By identifying these phases 132 dynamically, the processing unit 110 can apply targeted optimizations that would not be possible under a non-differentiated workload view, where execution is treated as homogeneous and resource usage patterns are obscured.

FIG. 1B illustrates a representational schematic of a behavioral sensor 120 for generating output including behavioral indicators 108. In this embodiment, the behavioral sensor 120 includes a feature extractor 122 and a classifier 124. The feature extractor 122 is coupled to the processing unit 110 (or another device) to receive a stream 104 of processor-level execution events 106 generated during execution of code 102. The feature extractor 122 identifies salient features of individual events in the stream and associates them with timing information. In some embodiments, a buffer (not shown) is used to capture the event stream prior to feature extraction, while in others the feature extractor 122 is robust enough to directly process events arriving from a processor trace or PMU interface.

The feature extractor 122 may be implemented as, for example, a programmable binary state machine, a binary pattern matching engine, a bitstream pattern matcher, a path signature extractor, digital filter, statistical calculator, or other suitable circuitry (including more complex circuitry with or without acceleration). A programmable binary state machine examines events bit by bit, traversing defined states to identify one or more features. A bitstream pattern matcher compares larger fields of an event record (or even the entirety of the record) against predefined patterns. A path signature extractor applies high-dimensional analysis to a sequence of events to derive a unique signature of a path or behavior segment.

As noted, the feature extractor 122 associates each event with timing information. The extracted features may correspond to events of interest such as PMU-monitored outcomes (e.g., branch mispredict, load retired, store retired, branch retired, cache miss). Timing may be measured using a counter within the behavioral sensor 120 or externally by the processing unit 110. The time can be absolute (e.g., wall-clock values such as second, minute, hour, date) or relative (e.g., cycle differences between consecutive events). In one embodiment, relative time is compressed using delta values, optionally with a ceiling value (e.g., 1,000 cycles) enforced by a saturating counter to avoid unbounded representations.

The classifier 124 receives the features identified by the feature extractor 122 and assigns them to one or more predefined categories that correspond to behavioral indicators 108. Classification may include assignment of a confidence measure, rather than binary membership, quantizing the degree of fit (e.g., on a scale of 0-255). The resulting classified events, together with their associated timing, form a temporal series of behavioral indicators 108 that can be consumed by the phase inference engine 130. In some embodiments, the classifier 124 outputs labeled vectors representing values for a subset of categories. Suitable classifier types include nearest-neighbor or approximate-nearest-neighbor classifiers, decision trees, support vector machines, gradient-boosted models (e.g., XG-Boost), or other machine learning techniques. In other embodiments, classifier 124 may employ behavioral locality-sensitive hashing (bLSH) for approximate similarity matching.

In certain embodiments, the labels output by the classifier 124 may be arbitrary in the sense that they are chosen for convenience or design preference rather than inherent necessity. For example, labels may have semantic meaning to a program (e.g., unique identifiers for hashes of basic blocks), may be hand-crafted for known behaviors, or may be learned automatically in an unsupervised or semi-supervised manner. Generally, the phase inference engine may operate regardless of whether it was trained in supervised, unsupervised, or semi-supervised modes, enabling adaptive labeling and inference across varying availability of labeled data.

While classifier labels can be used directly for training phase inference models, alternatives are contemplated. For instance, intermediate embeddings may be produced that project dynamic features into a space that preserves similarity. Such embeddings can accelerate training convergence for complex phase detection models and facilitate knowledge transfer across machine learning tasks.

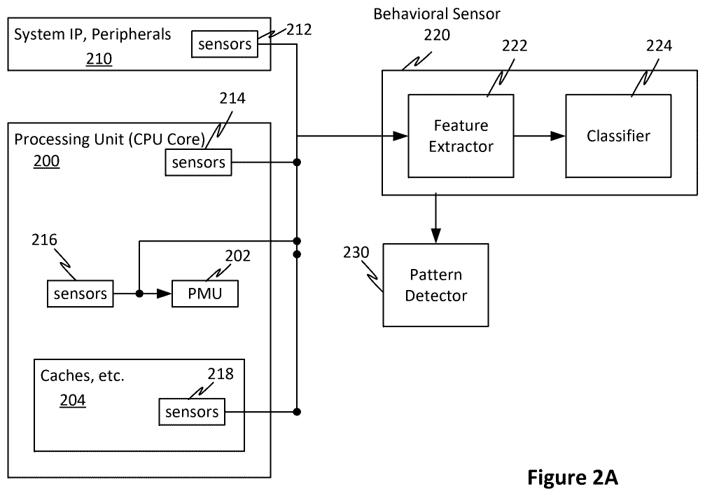

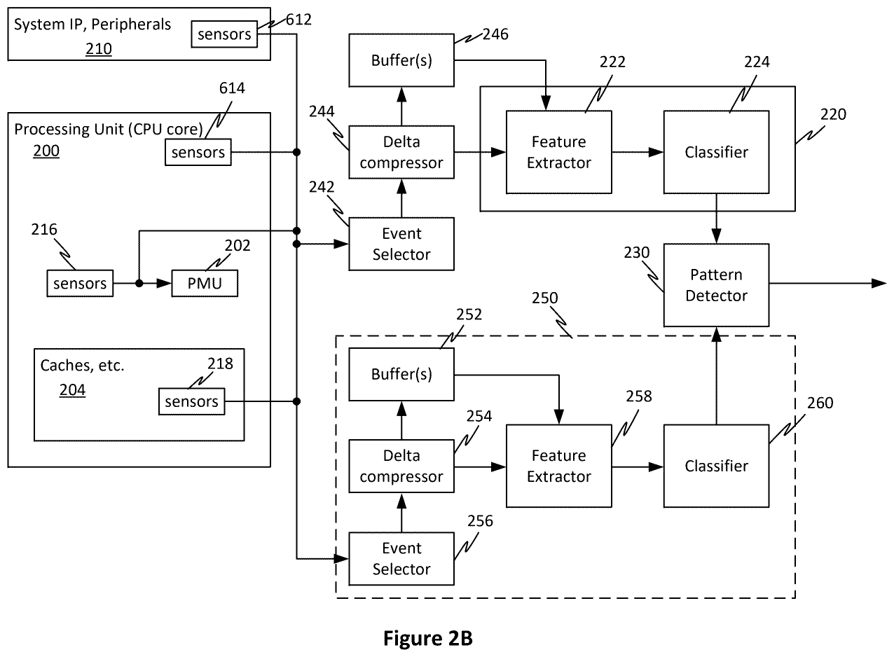

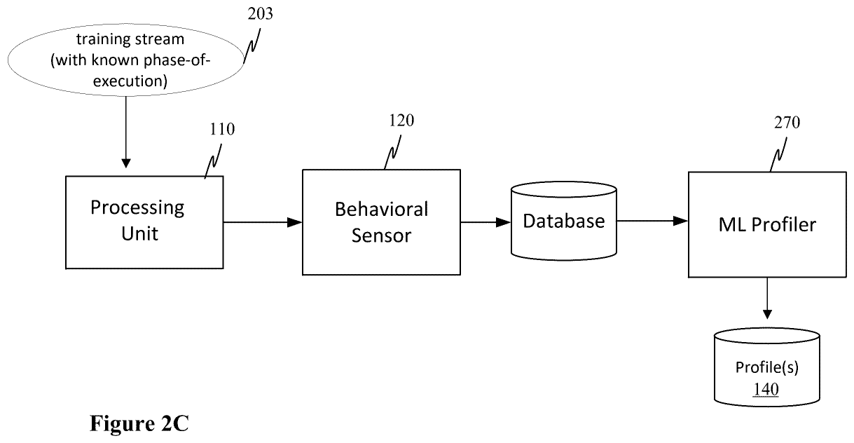

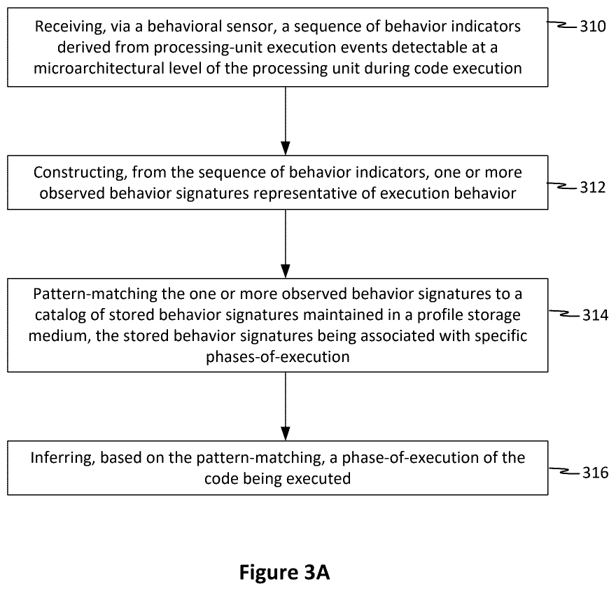

Although FIG. 1B depicts a behavioral sensor 120 with only a feature extractor 122 and classifier 124, alternative implementations may include additional circuitry or subsystems, such as those described in connection with FIGS. 2A and 2B. In some cases, intermediate values from the feature extractor 122 may be exported or made observable, enabling hybrid or multi-stage analysis pipelines.

In further embodiments, waypoints and hints can be employed to augment operation of the feature extractor 122 and classifier 124. Waypoints represent specific milestones or markers injected into a program's execution path, while hints comprise contextual information or annotations (such as compiler-inserted signals) that provide additional guidance. These can assist the classifier in recognizing intent or higher-level program structure. For example, a compiler could inject dummy instructions each time a data stream requires sorting, providing a waypoint detectable by the behavioral sensor 120. In some embodiments, hints may be detected by auxiliary sensors such as sensors 212, 214, 216, or 218 shown in FIG. 2A.

FIG. 2A illustrates a specific implementation of a system with a behavioral sensor used to determine phase-of-execution from processing unit events. Referring to FIG. 2A, a computing system can include a processing unit 200, such as a CPU core, system interfaces and peripherals 210. The processing unit 200 can include a performance monitoring unit (PMU) 202 and memory 204. The processing unit 200 can execute commands/instructions stored in the memory 204. As commands/instructions are performed, certain activities, operations, and behaviors at the processing unit 200 and the system interfaces and peripherals 210 may be considered events.

A number of sensors can be distributed throughout the computing system to detect various events and states. For example, one or more sensors 212 can be located at the system interfaces and peripherals 210, one or more sensors 214 can be located at the processing unit 200, one or more sensors 216 can be for monitoring by the PMU 202, and one or more sensors 218 can be located associated with memory 204 (e.g., caches and memory management, etc.). In the illustrated scenario a behavioral sensor 220 is included to create behavioral indicators from the events (e.g., processing unit events) detected by the various sensors 212, 214, 216, 218 for a pattern detector 230 (e.g., phase inference engine 130) used for determining phase-of-execution.

Behavioral sensor 220 includes feature extractor 222 and classifier 224, which can be configured as described with respect to the behavioral sensor 120 of FIG. 1B. Preprocessing circuitry can be included (and considered part of behavioral sensor 220 or part of the coupling circuitry to the processing unit 200).

FIG. 2B illustrates a specific implementation of the preprocessing circuitry present in some embodiments of the system of FIG. 2A. The preprocessing circuitry can include an event selector 242, a cycle delta compressor 244, and one or more buffers 246. Of course, certain embodiments may omit one or more of these circuit elements and certain embodiments may include additional circuit elements in addition to or in place of the event selector 242, cycle delta compressor 244, and one or more buffers 246.

The event selector 242 can receive input of events of the event stream from one or more sources (e.g., from any of sensors 212, 214, 216, 218) and selects events based on one or more criteria. The criteria can include type of processor commands, number of cycles, or other predefined constraints. The event selector 242 is used to constrain the complexity of the feature extractor 222 so that the feature extractor 222 works from a subset of signals. That is, the event selector 242 provides a reduced event stream to the feature extractor 222. The event selector 242 can be embodied as a multiplexor, wherein a select line of the multiplexor can determine whether to allow an event on a bus line of the multiplexor to pass. The select pin can be controlled externally, for example by a processor that only allow certain events to pass. In other instances, the select pin can be coupled to a particular sensor or PMU to only allow events from particular sources. In other cases, a particular bit of the event can be fed to the select pin (e.g., an event comprising of seven bits can include six bits of data about the event and one bit that is used as a flag). In another implementation, the event selector can be a bit-mask that merges multiple sources of events into a single bitstream (e.g., combining loads and stores into a single “load or store” event).

The cycle delta compressor 244 can be used when relative time is used as the time value in the time series to determine the number of cycles between valid events. Because CPUs do not generate events on every cycle, the delta compressor 244 can be used to compress 0-space with run-length-encoding. That is, the delta compressor 244 can count the number of empty samples and save this delta as the cycle delta from the previous non-empty sample. In this manner, the cycle delta compressor 244 generates a count of a number of empty cycles between events of the event stream. The delta compressor 244 can include a counter (e.g., in the form of a number of flip-flops connected in cascade). The counter can be regularly incremented, for example by a clock circuit. When a valid event is received, the counter can be read and the value (that is the differential in time between two valid events) can be stored as the time and forwarded with the event. The counter can then be reset. In some cases, the counter used in the delta compressor 244 can be a saturating counter, wherein a ceiling value is included, beyond which the counter cannot increment. For example, the ceiling value can be 1,000 cycles—if an event were to occur more than 1,000 cycles after an immediately previous valid event, then a value of 1,000 cycles can be assigned as the time despite the actual number of cycles being greater than 1,000.

The one or more buffers 246 can serve to slow down receipt of events. In some cases, events are produced at a greater rate than can be processed by the feature extractor 222 or classifier 224. To prevent these events from being discarded or conflicting with events currently being processed, a buffer 246 can be used to store events until the feature extractor 222 or classifier 224 are ready. The buffer 246 can be, for example, a digital buffer, storage resource, static random-access memory (SRAM), or flip-flop circuit. In some cases, the buffer 246 automatically pushes received events to the feature extractor 222, and, in other cases, the buffer 246 receives a signal from the feature extractor 222 or the classifier 224 that indicates that the previous event has been processed by one or both of the feature extractor 222 and the classifier 224. In some cases, there may be an additional buffer between the feature extractor 222 and the classifier 224.

Additional event collection systems 250 can be included as part of the system (with consumable events provided to the pattern detector 230), each including their own buffers 252, cycle delta compressor 254, event selector 256, feature extractor 258, and classifier 260.

Pattern detector 230 (e.g., phase inference engine 130) can be considered a security system such as described in FIG. 1A. In some cases, pattern detector 230 can be a higher order machine learning or statistical system implemented, for example, with neural networks, deep learning techniques. Pattern detector 230 can perform high-level decisions on mitigation and reporting.

FIG. 2C shows a schematic diagram where a machine learning (ML) profiler 270 establishes the behavioral signatures of the profile storage medium. Generally, a training stream 203 having a known phase-of-execution is conveyed to the processing unit 110. Behavioral sensor 120 consumes a sequence of behavioral indicators generated from processing unit events, which are generally placed in a database or a persistent storage. In certain embodiments, training data can be generated by replaying known executions through the behavioral classifiers or by sampling real data from the field. Cached or persisted training data can be sanitized prior to being utilized by ML profiler 270. The ML profiler 270 discovers patterns in the sequence of behavior indicators and creates signatures, which are indexed to the known phase-of-execution. The more diverse training streams 203 that are used, the greater the ability of the ML profiler 270 to determine unique signatures for different phases-of-execution. The particular loss functions used during training are not limited to any specific formulation; examples may include cross-entropy, mean-squared error, Kullback-Leibler divergence, contrastive, or other differentiable objectives, and other loss functions can equivalently be employed.

In some embodiments, the generative feedback loops can be implemented to create a cyclic process to enhance model performance. For instance, a feedback loop may exist from ML profiler 270 that is established before or after behavioral sensor 120, Feedback loops are common for generative methods such as generative adversarial networks (GANs) or semi-supervised methods, which may make resulting models more robust than otherwise. During training, approximate nearest-neighbor (ANN) search techniques (e.g., kNN, HNSW) may be applied to cluster similar behavioral signatures and accelerate labeling of large datasets.

In some embodiments, unsupervised learning methods (e.g., clustering or autoencoding) are used, internally, (by ML profiler 270) to train across a large unstructured, unlabeled, or partially labeled corpus of behavioral indicators, which permits a very efficient mapping of an incoming stream of behavior indicators to a discrete internal state space (e.g., a finite set of internal phase-of-execution labels {1, . . . , S}. In some situations, behavioral indicators can be labels output from the consumable behavioral sensor, from intermediate path signatures, or from vectors or embedding of either. In certain embodiments, a combination of pre-existing phase-of-execution labels with learned labels can be used in a semi-supervised fashion. Graph autoencoder models may be used to learn normal behavioral transition graphs, with deviations or high reconstruction error indicating anomalous or unexpected execution behavior.

As mentioned, the training process involves ordered sequences of behaviors performed by an application. This ordering implies that there are a number of ways a higher-level model can interpret or consume behavioral sequences. For example, transitions can be modeled using graph structures. Alternatively, a convolutional neural network can be used for modeling. In a different implementation, tokens can be fed to attention-based models like transformers. While transformers can be fairly expensive, one model can be trained that is able to recognize all important behaviors, which can be distilled/transferred to other models using techniques, such as though teacher-student processes.

In some circumstances, aggregating transitions between discrete states over a window of time (e.g., meta-window) naturally yields a graph model, where each node corresponds to an internal state and each edge is annotated with the frequency or probability of a state transition. The complexity of storing such a graph never exceeds S*S, regardless of how long the time window is. In practice, however, sparsity can be controlled via a size of the meta-window and the cardinality of the state space.

Graph features can be useful in both unsupervised and supervised settings. In unsupervised settings, sudden and persistent changes to the graph's transition matrix indicate that there has been a change in the behavioral phase-of-execution. Anomalies can also be detected when an incoming graph state differs from known, trusted, state graphs.

An example of a model is a Graph Autoencoder, which can be trained on a database of known and trusted behaviors. Sudden changes in an internal representation of the Graph Autoencoder correspond to changes in the behavioral phase-of-execution. High reconstruction errors correspond to anomalous behavior.

In a supervised setting, the graph-based method provides an additional mechanism for classifying known behavioral phases-of-execution (e.g., using a pre-trained graph neural network) with additional benefits of being able to increase a time window (e.g., meta-window) without increasing computational or storage complexity.

Another example of a model is an agentic model, where a sequence can be seen as a continuous loop of perceiving, reasoning, planning, acting, and learning actions performed to achieve defined goals. The perceiving, reasoning, planning, acting, and learning cycle may correspond to adaptive control-plane operations that autonomously reconfigure processor resources. In such a model, a transformer can distill one sequence into a subset of actions for distinct AI agents. Outputs of such a model can include control plane information for a processor reconfiguration.

An additional example of a model can use an recurrent neural network (RNN)-based classifier. RNNs are well suited for analyzing time-series data due to their ability to process sequential information and to capture temporal dependencies and patterns within data points that occur over time.

FIG. 3A illustrates an example method 300 of inferring a phase-of-execution of code in a processing unit. For example, two identical instruction sequences can exhibit different behavioral signatures when executed under varying data or memory conditions, demonstrating that dynamic measurement, not static structure, determines phase. Unlike structural approaches correlating phases to code regions, the disclosed behavioral method can base phase inference solely on dynamic execution behavior.

At step 310, a behavioral sensor receives a sequence of behavior indicators derived from processor-level execution events detectable at the microarchitectural level during code execution. At step 312, the sequence is processed to construct one or more observed behavior signatures representative of execution behavior. At step 314, the observed signatures are pattern-matched against a catalog of stored behavior signatures maintained in a profile storage medium, each stored signature corresponding to a known phase-of-execution. At step 316, a phase-of-execution of the running code is inferred based on the pattern-matching. In some embodiments, this inference is performed in near real time and in a platform-independent manner, without reliance on source code structure or compilation details, thereby enabling applicability across workloads and environments.

In certain embodiments, inference may occur prior to execution of instructions for a subsequent phase, allowing tuning actions to be applied proactively. The execution events used to generate behavior indicators can include instruction retirements, cache accesses, memory transactions, or interconnect traffic, and may be gathered from multiple distributed sensors spanning a core pipeline, cache, memory controller, or interconnect. Phases-of-execution inferred through this process can represent identifiable intervals of execution characterized by recurring microarchitectural event patterns observable across these subsystems.

Construction of behavior signatures at step 312 may employ temporal ordering, windowing, hashing, or compression. For example, successive indicators may be correlated to capture ordered event sequences, progressively updated windows may form localized representations, hashes may be computed for compact matching, and compression such as run-length encoding, dictionary-based schemes, or entropy coding may be applied while preserving distinguishing features. Pattern-matching at step 314 can involve evaluating a similarity metric between the observed and stored behavior signatures, such as by applying quantitative measures such as Hamming distance, edit distance, or statistical correlation. In some cases, pattern-matching may employ approximate nearest-neighbor (ANN) search structures, such as k-Nearest-Neighbor or Hierarchical Navigable Small-World (HNSW) graphs, to efficiently locate similar behavior signatures. Inference at step 316 may yield multiple candidate phases with associated confidence values, refined until a threshold is met, and can in some cases identify both phases and sub-phases of execution within a hierarchical signature catalog.

In some embodiments, constructing behavior signatures may additionally employ linear transforms, such as matrix multiplication or convolution, to project behavioral features into a transformed space suitable for subsequent pattern matching.

FIG. 3B illustrates an example method of predicting a subsequent phase-of-execution of code in a processing unit. At step 320, a behavioral sensor receives a sequence of behavior indicators derived from microarchitectural execution events observed during code execution. At step 322, the temporal order of the indicators in the sequence is analyzed to capture dynamic execution flow. At step 324, this temporal information is compared against a catalog of stored behavior patterns associated with specific phases-of-execution. At step 326, a subsequent phase-of-execution of the code is predicted based on the comparison, prior to execution of instructions corresponding to that phase.

In some embodiments, the analysis at step 322 may involve constructing behavior signatures that explicitly encode the temporal ordering of indicators, enabling robust comparison against stored profiles. Such signatures can be formed using techniques including sequence correlation, progressive windowing, or temporal hashing, allowing the system to capture distinctive timing-dependent execution patterns. The comparison at step 324 can be performed using pattern-matching algorithms, which may rely on similarity metrics such as edit distance, statistical correlation, or other sequence-alignment measures.

FIG. 3C illustrates an embodiment of tuning processor resources based on a predicted phase-of-execution. At step 330, an upcoming phase-of-execution is predicted, for example using the techniques of FIG. 3B where temporal patterns of behavioral indicators are matched against stored behavior profiles. At step 332, the system proactively tunes one or more processing-unit resources based on the predicted phase, prior to execution of instructions corresponding to that phase.

In some embodiments, the tuning may include adjusting cache allocation policies, enabling or disabling hardware prefetchers, modifying memory controller scheduling, or reallocating execution pipeline resources in anticipation of the upcoming workload. For example, if the predicted phase corresponds to a compute-intensive region, pipeline depth and scheduling may be adjusted to maximize throughput; conversely, if the predicted phase corresponds to a memory-bound region, cache hierarchies or prefetch mechanisms can be configured to minimize latency. By performing such actions before the upcoming phase begins, the system overlaps optimization with the phase transition itself, ensuring performance benefits without incurring the delays of reactive adjustment.

FIG. 3D illustrates an embodiment for generating a catalog of behavior signatures through supervised training. At step 340, a set of training execution streams is processed, each stream being annotated or otherwise associated with known phases-of-execution. At step 342, a sequence of behavioral indicators is generated from the training execution streams, for example using a behavioral sensor as described above. These behavioral indicators capture salient features of microarchitectural execution behavior.

At step 344, the sequences are conveyed to a machine learning profiler or statistical profiler configured to extract recurring patterns across the training data. The profiler may apply classification, clustering, or other learning techniques to group and differentiate behavior indicators according to the known phases. At step 346, the results are consolidated into a catalog of stored behavior signatures, which represent characteristic execution patterns associated with specific phases-of-execution.

In some embodiments, the generated catalog can encode signatures as temporal sequences, statistical distributions, compressed hashes, or learned embeddings, depending on the profiling technique. In other embodiments, hierarchical signatures may be constructed so that both high-level phases and sub-phases can be identified, thereby defining a hierarchical organization of the catalog of stored behavior signatures. The catalog produced in FIG. 3D provides the reference data against which observed behavior signatures (FIGS. 3A and 3B) are pattern-matched, thereby enabling inference and prediction of execution phases in real-world code streams. In some embodiments, a meta-window may represent an accumulation of behavioral transitions over a bounded time window, forming a graph where nodes correspond to internal states and edges represent transition frequencies. In certain implementations, the number of graph edges scales as S×S, where S is the number of internal states, but sparsity can be maintained by bounding the meta-window or constraining state cardinality.

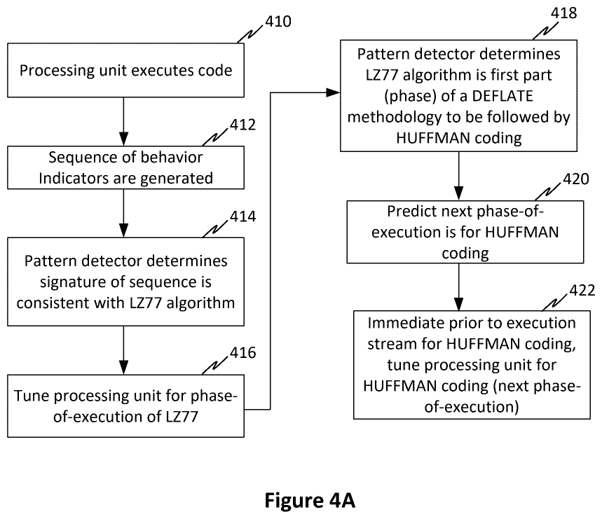

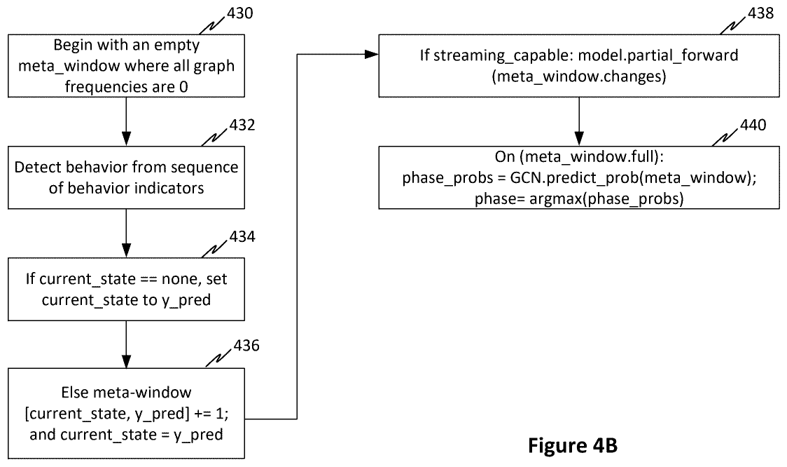

FIG. 4A provides a sample use case for predicting phase-of-execution and for responsively tuning a processing unit to improve performance. FIG. 4A is an illustrative use case where behavioral phase-of-execution detection is used to identify whether a longer running execution stream is similar enough to some pre-established workload to statistically effectuate a performance improvement. Effectively, the processing unit is able to determine a program (e.g., code) is running some variant of Lempel-Ziv77 (LZ77), which is a first part of ZIP's DEFLATE methodology and will likely run HUFFMAN coding in the next phase-of-execution. The ability to chain together different behaviors at different resolutions and to then reason based on these behaviors provides a heretofore untapped manner to improve processing efficiency/performance.

In step 410, the processing unit executes code. In step 412, a sequence of behavior indicators is generated. In step 414, the pattern detector (e.g., phase inference engine 130) determines a signature of the sequence is consistent with the LZ77 algorithm. Should the LZ77 (in an execution state after the determination is made) have an associated optimization/tuning for the remaining processing (significant enough to offset overhead accounting for uncertainty of the determination), step 416 can be performed, where the processing unit/related resources are tuned for LZ77 processing. A level of latency is involved in inferring a current phase from behavior of code running in that phase, which may minimize a value in a performance optimization. However, some phases-of-execution are able to predict future phases of execution, which avoids latency type issues.

In step 418, the pattern detector can be trained to know that the LZ77 algorithm is a first part (phase) of a DEFLATE methodology that is paired with a second part (phase) of HUFFMAN coding. In step 420, the next phase-of-execution can be predicted as a HUFFMAN coding phase. This prediction occurs prior to the HUFFMAN phase-of-execution executing. In step 422, immediately prior (approximately) to a handling of an execution stream for HUFFMAN coding, the processing unit and related resources can be tuned for the HUFFMAN coding, which was identified as the next phase-of-execution.

In the example of FIG. 4A, the phases-of-execution as labeled/utilized equate to a LZ77 phase and a HUFFMAN coding phase, which are relatively high order behavior-based phases. Different phase-of-execution categories are contemplated and labels associated with phases-of-execution can be directly associated with a part of a program (e.g., code), can be learned in an unsupervised fashion, or can be a combination of the two taking a semi-supervised form.

From the example, the phase-of-execution detection process consumes behavioral indicators and determines approximate phase similarity and correlates this with inter-phase transitions via graph structures. Roughly speaking in certain embodiments, output can be a vector representing a behavioral measurement in compressed form along with a multilabel list of relevant identified behaviors and their corresponding scores. In some embodiments, each behavior signature may be represented as a vector pair (x_signature, y_pred) comprising a compressed embedding of observed features and one or more predicted phase labels, optionally expressed as multilabel vectors with probability scores.

A sequence of behavior indicators is consumed to identifying a behavioral signature, a predicted future phase-of-execution (e.g., HUFFMAN coding from LZ77 signature matching), or both to identify higher order behaviors present in the handling of an execution stream. This can be considered examining a behavioral phase over some meta-window. Dynamic behavior measured and utilized during this process, which is contrasted with an approach of correlating phase-of-execution to structure of code that is not dynamically measured.

FIG. 4B provides a simple machine learning example consistent with FIG. 1A. The example works for both supervised and unsupervised learning. In a supervised case, labels for phase-of-execution are predicted from a consumable behavior signature. In an unsupervised case, an additional stage is added that consumes raw behavior signatures and outputs labels for phase-of-execution. For instance, relatively lightweight classifiers such as k-Nearest Neighbor (kNN) or Hierarchical Navigable Small World (HNSW) graphs may be used to assign labels. In either case, the core insight is that the behavioral signature captures what the code does (its dynamic behavior at the microarchitectural level), rather than how the code is written or structured.

In the illustrated example, processing begins with an empty context window in which all graph frequencies are initialized to zero (step 430). As behavioral indicators are received, the system detects execution patterns and updates this window (step 432). If no prior state exists, the current prediction variable is initialized (step 434); otherwise, the context window is incrementally updated to reflect the transition from the prior prediction to the current one (step 436). If streaming capability is enabled, partial updates may be applied in real time (step 438), such as executing a partial forward pass of the model on recent changes. Once the context window is complete, the system computes probability scores for candidate phases (phase_probs) using, for example, a Graph Convolutional Network (GCN), and selects the highest-likelihood phase as the prediction (step 440). Alternative prediction frameworks, such as Bayesian estimators or Hidden Markov Models (HMMs), may be employed to update the likelihood of a next phase conditioned on the current phase.

In the example of FIG. 4B, the only case considered is where the top label for phase-of-execution is emitted. In some embodiments, vectors of labels can be consumed rather than relying on a single label. For example, a Cartesian product of label vectors can be updated with probability weights, so that transitions between labels are scored proportionally to their likelihood. In symbolic form:
[y_00:p00, y_01:p01]×[y_10:p10]→[y_00→y_10:p00*p10,y_01→y_10:p01*p10]
   Put differently, the system considers multiple candidate transitions (y_00 to y_10, y_01 to y_10, etc.) weighted by the joint probabilities, enabling phase-forecasting beyond the top prediction. In some embodiments, an attempt to forecast a next phase can occur that is based on current measurements.

In certain embodiments, additional offline processing can be applied to build ontologies around the output meta-labels, irrespective of how those labels were initially assigned. For example, similarity search or projection can be performed on meta-windows, allowing the system to assign or reassign meta-labels based on structural proximity of execution behaviors. This ensures that different behaviors that are close enough in structure are treated consistently, thereby yielding the same or compatible optimizations. By introducing this semantic layer, the system reduces fragmentation in the label space and improves the reliability of tuning actions across workloads.

In another example, multiple unsupervised models can be cascaded or arranged in a sequence with output of one model serving as input for the next. Cascading models allows the system to tackle complex problems by breaking them down into smaller, more manageable subproblems, each handled by a specialized unsupervised model. For example, a K-Nearest Neighbor (KNN) algorithm can be use a Softmax function as a single meta-label proxy. In another example, labels can be projected into an embedding and a top-K pairwise estimation can be performed.

In certain embodiments, ontologies can be built (offline) around output meta-labels irrespective of how the labels are assigned. For example, a search projection on meta-windows can be executed to assign/reassign meta-labels, which can ensure behaviors are close enough in structure to yield the same optimizations.

Taken together, FIGS. 3A-3D and 4A-4B describe a closed-loop workflow in which training produces a catalog of behavior signatures (FIG. 3D) that is consumed at runtime to infer current phases (FIG. 3A), predict upcoming phases (FIG. 3B), and proactively tune processing-unit resources (FIG. 3C). The runtime pipeline operates on processor-level, microarchitectural events rather than source-level constructs, enabling platform-independent inference without reliance on code structure or compilation details. The predictive/tuning path allows optimizations to overlap phase transitions (e.g., LZ77→HUFFMAN in FIG. 4A), and learning components (FIG. 4B) can update or refine the catalog over time.

In certain embodiments, portions of the behavioral sensor, signature construction, and inference logic execute in firmware or hardware positioned proximate to microarchitectural telemetry sources (e.g., a PMU, trace fabric, or other on-die observability interfaces) to meet latency targets, while catalog management and model updates may execute in software. In other embodiments, these functions may reside in any combination of on-core microcode, on-die accelerators, near-die controllers, system firmware, a co-processor, or host software processes. Confidence scores and thresholds govern when to emit phase determinations or apply tuning actions, and hierarchical signatures permit identification of both phases and sub-phases. This arrangement preserves event-level fidelity and enables low-latency, real-time decisions without requiring prior knowledge of the application's codebase, and is not limited to use of a PMU or any particular deployment topology.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

What is claimed is:

1. A method of inferring a phase-of-execution of code in a processing unit comprising:
receiving, via a behavioral sensor, a sequence of behavior indicators derived from processing-unit execution events detectable at a microarchitectural level of the processing unit during execution of code;
constructing, from the sequence of behavior indicators, one or more observed behavior signatures representative of execution behavior;
pattern-matching the one or more observed behavior signatures to a catalog of stored behavior signatures maintained in a profile storage medium, the stored behavior signatures being associated with specific phases-of-execution; and
inferring, based on the pattern-matching, a phase-of-execution of the code being executed.

2. The method of claim 1, wherein the inferring is performed prior to execution of instructions corresponding to a subsequent phase-of-execution.

3. The method of claim 1, wherein the processing-unit execution events include at least one of instruction retirements, cache accesses, memory transactions, or interconnect traffic.

4. The method of claim 1, wherein the behavioral sensor comprises a plurality of sensors distributed across subsystems of the processing unit, the subsystems including a core pipeline, a cache, a memory controller, or an interconnect.

5. The method of claim 1, wherein the phase-of-execution comprises an identifiable interval of code execution characterized by recurring patterns of microarchitectural events observable across one or more subsystems of the processing unit.

6. The method of claim 1, wherein constructing the one or more observed behavior signatures comprises processing the sequence of behavior indicators using one or more of temporal ordering, windowing, hashing, linear transforms, or compression to generate a representation of execution behavior suitable for pattern-matching.

7. The method of claim 1, wherein the constructing of the one or more observed behavior signatures comprises:
correlating successive ones of the sequence of behavior indicators according to their temporal order to generate a signature capturing the sequence of microarchitectural events during execution of the code.

8. The method of claim 1, wherein the constructing of the one or more observed behavior signatures comprises:
applying a progressively updated window to the sequence of behavior indicators to generate a windowed representation of execution behavior.

9. The method of claim 1, wherein the constructing of the one or more observed behavior signatures comprises:
computing a hash of the sequence of behavior indicators, which are temporally ordered, to generate a compact signature suitable for pattern-matching with the stored behavior signatures.

10. The method of claim 1, wherein the constructing of the one or more observed behavior signatures comprises:
compressing the sequence of behavior indicators using a data compression technique configured to preserve distinguishing features of execution behavior, wherein the data compression technique comprises one of run-length encoding, dictionary-based compression, entropy coding, or statistical coding.

11. The method of claim 1, wherein the pattern-matching the one or more observed behavior signatures to the catalog of stored behavior signatures comprises:
correlating a temporal order of the observed behavior signatures with a temporal order of the stored behavior signatures to determine a degree of correspondence.

12. The method of claim 1, wherein the pattern-matching of the one or more observed behavior signatures to the catalog of stored behavior signatures comprises:
evaluating a similarity metric between the observed behavior signatures and the stored behavior signatures.

13. The method of claim 12, wherein the similarity metric comprising one of Hamming distance, edit distance, or a statistical correlation measure.

14. The method of claim 1, wherein the inferring of the phase-of-execution comprises identifying multiple candidate phases each with an associated confidence value.

15. The method of claim 1, wherein the inferring of the phase-of-execution comprises computing a confidence value from a degree of correspondence and determining the phase-of-execution when the confidence value exceeds a threshold.

16. The method of claim 1, wherein the inferring of the phase-of-execution comprises:
identifying both a phase and a sub-phase of execution according to a hierarchical organization of the catalog of stored behavior signatures.

17. A method of predicting an upcoming phase-of-execution of code in a processing unit, comprising:
receiving, via a behavioral sensor, a sequence of behavior indicators derived from processing-unit execution events detectable at a microarchitectural level of the processing unit during execution of code;
analyzing a temporal order of the behavior indicators in the sequence;
comparing the temporal order of the behavior indicators to a catalog of stored behavior patterns associated with specific phases-of-execution; and
predicting, based on a comparison resulting from the comparing, a subsequent phase-of-execution of the code prior to execution of instructions corresponding to the subsequent phase-of-execution.

18. The method of claim 17, wherein analyzing the temporal order of the behavior indicators comprises constructing one or more observed behavior signatures that encode the temporal order of execution behavior, and wherein the comparing comprises pattern-matching the one or more observed behavior signatures to the catalog of stored behavior patterns.

19. A system for inferring a phase-of-execution of code in a processing unit, comprising:
a behavioral sensor configured to capture a sequence of behavior indicators derived from processing-unit execution events detectable at a microarchitectural level of the processing unit during execution of code;
a profile storage medium configured to store a catalog of behavior signatures associated with specific phases-of-execution; and
a phase inference engine configured to:
construct one or more observed behavior signatures from the sequence of behavior indicators;
pattern-match the one or more observed behavior signatures to the catalog of stored behavior signatures; and
infer, based on the pattern-matching, a phase-of-execution of the code being executed.

20. The system of claim 19, wherein the behavioral sensor comprises:
a feature extractor configured to process the processing-unit execution events; and
a classifier configured to output the sequence of behavior indicators.
